(19) United States
(12) Patent Application Publication
(10) Pub. No.: US 2006/0227667 A1
(43) Pub. Date: Oct. 12, 2006

(54) One or more portable remote devices involved with sports that can control time or whistle equipment on or off the playing area

(76) Inventor: Max Meier Stern, Lake Forest, CA (US)

Correspondence Address: MAX M. STERN, 24284 ONTARIO LANE, LAKE FOREST, CA, 92630, US

(21) Appl. No.: 11/101,432

(22) Filed: Apr. 8, 2005

(51) Int. Cl. G04F 10/00; G04F 8/00

(52) U.S. Cl. 368/110; 368/113

(57) ABSTRACT

One or more remote control devices used at a sports event, by one or more officials, at that game, on activation can control, compatible game time pieces, without interference, that are located, on or off the playing field, with the option of initiating the sound of a whistle at activation location, or from compatible equipment, that are on or off the field, without any game time piece being altered.

### CROSS-REFERANCE TO RELATED APPLICATIONS

The title of the previous application was: A single remote device from on the sports field that controls time and whistle equipment on or off the field.
application Ser. No. 10/139,538
Filed on: May 7, 2002

The difference being in this case, is that more than one remote can be involved with a game and control whistle and time pieces on or off the field of play.

No exterior changes have been implemented on any related compatible components.

The internal electronic components in the housing of each remote has been supplemented with a receiver in the electronic circuit to receive the signal, from another remote, with the means that has already been provided, to produce a whistle sound at any location that a remote is being used.

The drawings are a repeat of the last application.

### STATEMENT REGARDING FEDERALLY SPONSORED RESEARCH OR DEVELOPMENT

Not Applicable

### Incorporated-by Referance of Material Submitted on a Disk

Not Applicable

### Sequence Listing

Not Applicable

### BACKGROUND OF THE INVENTION

Sports have rules and guidelines. To see that the sport is played according to the laws, an official or officials are on the playing area or sidelines, who interpret the rules as well as dispense decisions.

Electronics have assisted in making the task of officiating sports easier and more accurate.

In many cases the whistle and game time are still performed, by using air from the mouth to produce the whistle sound, with a hand action on the game time piece. The game time piece in many sports is normally activated by an official, in conjunction with but after the whistle sound is heard. This does cause a delay in real time, in regards to the game time being as accurate as it could be, whereby if a direct relationship between the whistle and game time piece where established the accuracy factor would be more realistic, therefore having electronics incorporated, as this remote device is fitted with, has eliminated the time lost, between the whistle sound and game time being controlled, with or without a whistle sound being heard.

The device of Fujita US-RE 29,720 dated August 1978 is a time correction apparatus. An official at a sports event can use this, although it is not a remote control. It does not have the option of sounding a whistle, nor the ability of sending a coded transmission or to receive a coded signal to perform the function of starting or stopping a game timepiece, nor to sound and control whistle related equipment.

The invention of Iwai et al U.S. Pat. No. 4,105,902 dated August 1978 is not meant to be used at a sports event. The action of this switch is a touch sensitive activation means, without the ability on activation, to sound a whistle, at activation location or transmit a signal to other equipment to sound a whistle, or start of stop a game time piece on or off the field.

The invention of Yamamoto U.S. Pat. No. 5,847,652 dated December 1998 does produce a whistle sound. The system uses two separate housings connected by a wire to complete the circuit, from activation to the mechanism that produces the sound. This device does not have any time related influence in its activation. My device fits into one housing, with the ability to control a game timepiece with or without the sound of a whistle, from on the field, by transmitting a coded signal, to other on or off the field, time or whistle compatible equipment.

The invention of Peljac U.S. Pat. No. 6,067,013 dated May 2000 is used by two sideline officials off the field of play, to obtain the attention of the main official on the field of play and to obtain the attention of other officials involved with the game. This device does not have the ability to sound a whistle, nor is it capable of controlling on or off the field game timepieces. This device when activated is normally waved in the air above the shoulders, to increase the visibility of the device, to officials, players and spectators, while my device once activated at any hand elevation, is not flashed around for visibility. More than one official, with my device, who is involved with the sport, at any time, can activate the whistle or game time piece from on the playing area or sidelines.

The invention of Poole U.S. Pat. No. 6,369,697 B1 dated April 2002 has the ability to control game related time pieces on or off the field, in a secure group. The mobile device has a single switch means to complete the circuit so that the signal to start or stop a related game time piece can be executed. This device at activation location does not have the ability to produce the sound of a whistle. The receiving equipment also does not have the means to produce a whistle sound at any location. My device at point of activation can produce a whistle sound as well as from any other remotes or compatible equipment, on or off the field of play.

The invention of Calace U.S. Pat. No. 6,603,711 B2 dated August 2003 discloses a remote that is capable of controlling time keeping devices on or of the field of play. This device on activation sends a signal that controls one or more game time pieces. This device has been configured to be worn as a glove, that requires a left or right hand, as well as sizes, .which are not mentioned, as well a wrist watch or a clip on device, which are both very impractical. My device when activated a whistle sound can be produced at activation location electronically, this does not signify that a game time piece is being sent a coded signal to perform any function. My device does not have a time piece in or on the remote. My device has two buttons that each performs two tasks. The whistle sound, with time piece activation button is slightly raised on my device, for ease of identification. The time piece activation button with learn mode sequence is slightly recessed on my device, so that it should not be activated inadvertently. My device can be worn from a strap or be carried in the palm of either hand, with no left or right hand, or sizes required.

None of the devices mentioned has a safety feature incorporated into any of the activation means. On pushing the whistle/time related button, on my device, resistance as the safety phase is encountered, allowing only the whistle sound related equipment to be activated on or off the field. The game time related equipment is sent a coded signal only when the activation means is pushed through this safety phase in its downward movement so that no mistake should occur, to start or stop a game time piece. None of those devices mentioned, which can include one or more remote controls for use at a sport event, for whistle or watch related equipment that are on or off the field, have considered the possibility of a malfunction, a component being lost, or being taken to another location, or one field being next to each other, so that they can be set up to function once again within a group. None of these devices mentioned, elaborate on how they are going to be made compatible to work within a group, should any one or more of the above situations arise, although they might have many combinations of coded signals. All of the above mentioned devices are susceptible to water damage that can cause them to malfunction, as none are waterproof.

My remote device or devices which can be located on or off the field address's all of these issues, so that a secure, all weather, easy to carry and setup means, works within a compatible group, allowing more than one field to be next to each other.

### SUMMARY OF THE INVENTION

This invention is a means with one or more hand held remote control devices, involved with that game, from on or off the playing surface, which can be carried in either palm of the users hand or worn from a cord, whereby on being activated a whistle sound can be heard, with the option of simultaneously transmitting a coded signal, that can control on or off the field game timepieces or whistle related sounding equipment. This device also has the means to control a game time piece with no whistle sound option, with the same activation means required to form a secure compatible group. This feature will become more understandable when the working details are described.

The components required to complete all aspects of this sports remote device, such as the two activation means, the speaker, the chip to produce a whistle sound, with various control boards, software, transmitters, receiver for sound activation, the power source and the strap for carrying, are all housed in or on the casing.

The device when it is going to be activated by an official involved with the game, from on the field of play or on the playing surface, he/she has various options. The reason being that to start the game a whistle is sounded and the game clock is started. This official can also activate the remote control to produce a whistle sound without transmitting a coded signal that involves the game time, as is most often the case at soccer or rugby. At basketball and American Football a whistle sound is an indication that a time piece is going to be involved. There are other sports that fall into the various categories that have time restraints, involving a whistle and time piece

The official or officials have the right to handle a scenario that has occurred concerning the game, with their own interpretation of the law, the way they have seen fit, in certain situations. The official or officials can decide to sound the whistle at activation location, with or without sending a signal to a game timepiece to start or stop the game. The same official having stopped the flow of the game, with a whistle only sound, or if there is more than one official at the game, then the head official generally is designated to restart the game with the sound of a whistle, which this control does accommodate, not involving any game timepiece. Then an official or officials can also decide to sound a whistle and send a separate simultaneous coded signal to the components that activates the game time piece. At some sports events more than one remote device is used, therefore the required internal electronic components have been included, allowing remotes, which are within that compatible group, to receive the coded signal and then produce a whistle sound. The reason for the whistle sound option is that it could be required at some events, thereby giving more flexibility to the devices many varied sports applications.

The remote control has two buttons for activation. The top button is slightly raised for easy identification without having to look, just sense of feel. This same activation means has a safety feature incorporated, so that no signal to a game timepiece should be forwarded inadvertently.

The process of pushing this activation means causes some resistance, allowing first, only the circuit for the whistle sound, with whistle sound transmission, to become operational. The speaker will emit a whistle sound on the field of play at the remote control and a signal in code will have been forwarded to any equipment compatible to this transmission, to repeat the sound of a whistle, even in a large stadium from sound equipment, or another control or even from a watch, so all present are capable of hearing the sound.

On pushing this same top button more firmly, it will pass through the safety phase, causing the circuit to be completed for the transmission of a coded signal to all, on or off the field related time pieces, causing the game time to start or stop, as desired by that official. The receiver in any compatible timepiece that has the correct electronics can accept this coded signal, as it has learned the code of that transmission, with the compatible mechanics imbedded in any game timepiece on or off the field.

The lower of the two activation buttons is slightly recessed in the housing. The reason being that it should not be confused with the top activation button. This means shares the same transmission circuit relative to the top button, for contacting only time related compatible equipment with no whistle sound option involved.

This lower button is integral and involved in creating compatibility between other equipment that has the capabilities to perform the functions of sounding a whistle or of changing the game time, on or off the field.

When an official or officials normally arrive at the field of play before the game starts, certain particular relevant things pertinent to the game have be to be checked out, be it at a swimming event or hockey game, such as the condition of the playing area, the lights, the nets, the corner flags, are all the lines or perimeters correctly marked, are the goals or posts in order, are the game time related watches on or off the field set correctly as well as making sure that his/her whistle works, be it air or electronic. This being the case, the equipment in this group has to be checked out to establish that all, on or off the field whistles or game timepieces are compatible and working in unison, as well as should their be more than one remote device involved with that event, it has also to be set up.

This is achieved by using one remote control, that the one or main official is going to use, who subsequently pushes down on the lower of the two activation buttons through the safety phase, to close the circuit of the learn mode sequence, for 3 seconds, as well as the learn mode button has to be pushed in simultaneously on any other remote device, timepiece or whistle equipment, on or off that field, with that technology and held down for 3 seconds to allow for compatibility, so they can work within a secure group. This will allow any watches, small or large visible time pieces to be brought in line, including any whistle sound apparatus on or off the field to be configured, to accept this signal in code. They can be done one at a time or collectively. This causes the software to recognize the coded signal that is going to be transmitted and received, from one or more involved field remote controls.

The reason for this feature being very important is that, should any compatible component malfunction, a new replacement can be configured to work within that group, also allowing more that one field to be alongside another, as it gives each group it's own coded compatible signal. Another very important reason for this feature is that this remote, or a complete other remote or remotes, can be taken to another location, or a different part of, off the field component of this equipment, can be moved and then be configured to work within another secure group to sound a whistle or control a game time piece.

These details with the features of this invention will become more apparent upon review of the description of the various adaptations and associated drawings that are appended hereto, It is from these materials as a whole that the scope of protection sought by the invention may be gleamed.

### BRIEF DESCRIPTION OF THE DRAWINGS

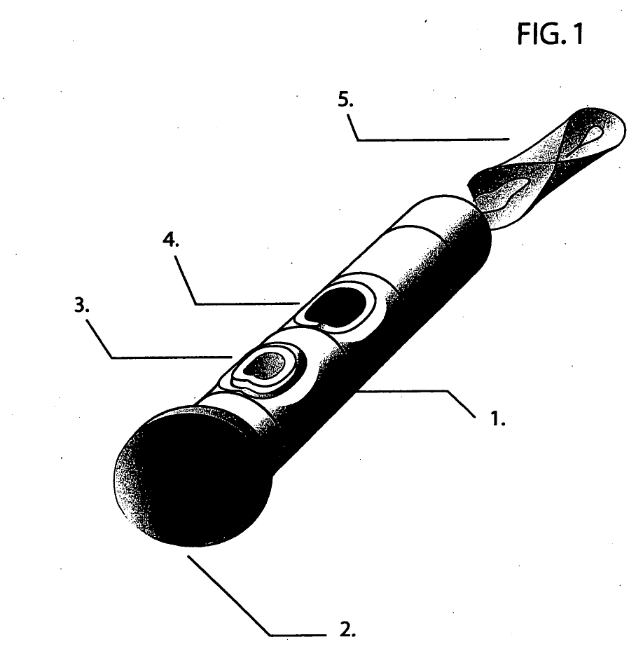

Drawing FIG. 1 is an outside side view of the remote housing control showing the placing of the external components.

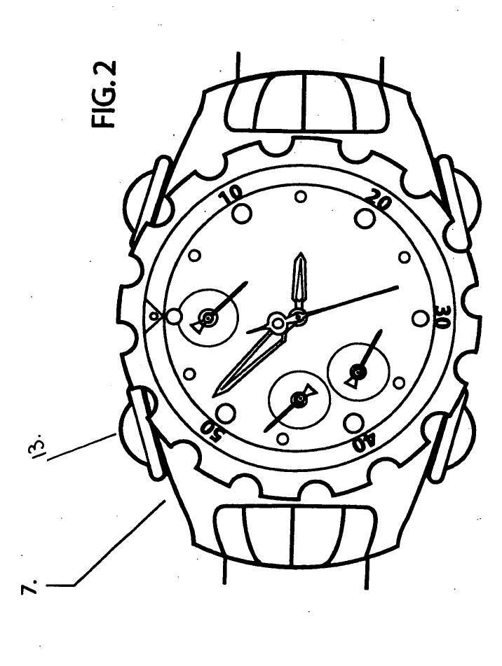

Drawing FIG. 2 is an outside top view of the game wristwatch or game clock.

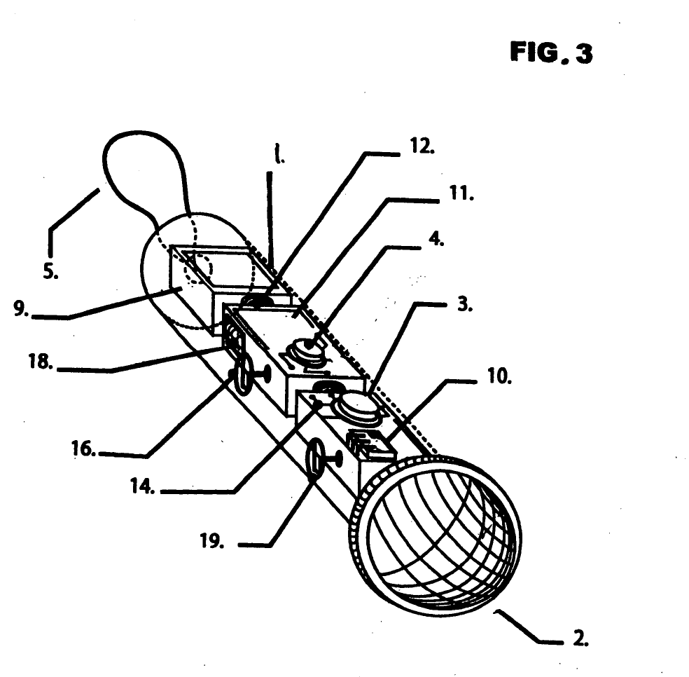

Drawing FIG. 3 is a cut away view of the inside of the housing showing the placement of all the relevant internal and external components.

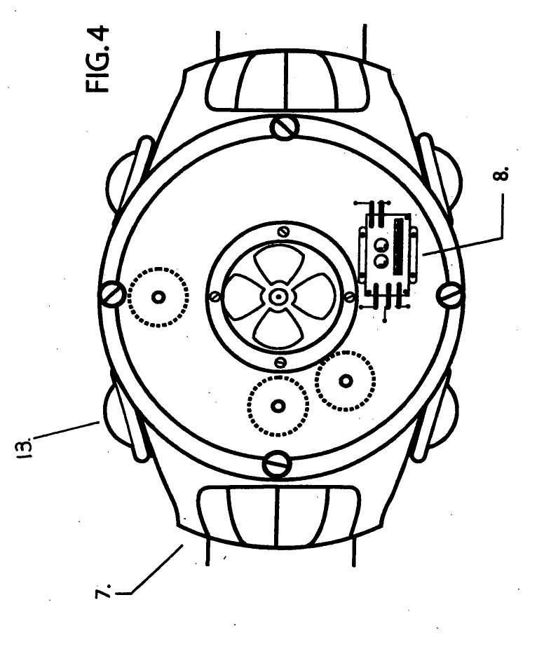

Drawing FIG. 4 is a front view of the watch or clock without the face showing the learn button and internal components.

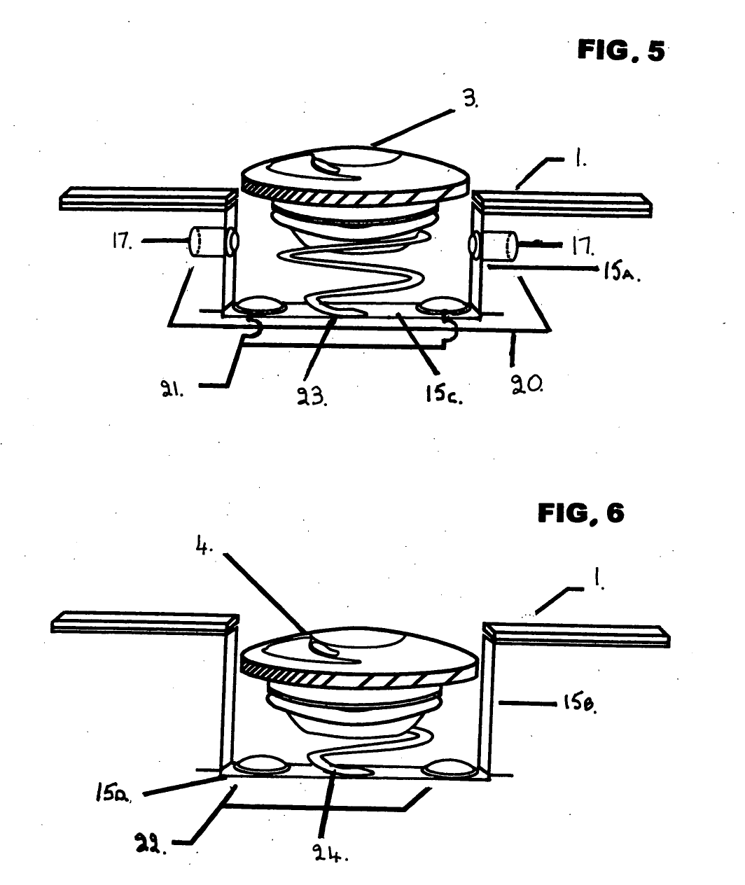

Drawing FIG. 5 is a side cut away view of the top button, showing it slightly elevated above the housing, with the wire connections outside of the waterproof cylinder.

Drawing FIG. 6 is a side cut away view of the lower button, showing it slightly recessed on the housing, with the wire connections outside of the waterproof cylinder.

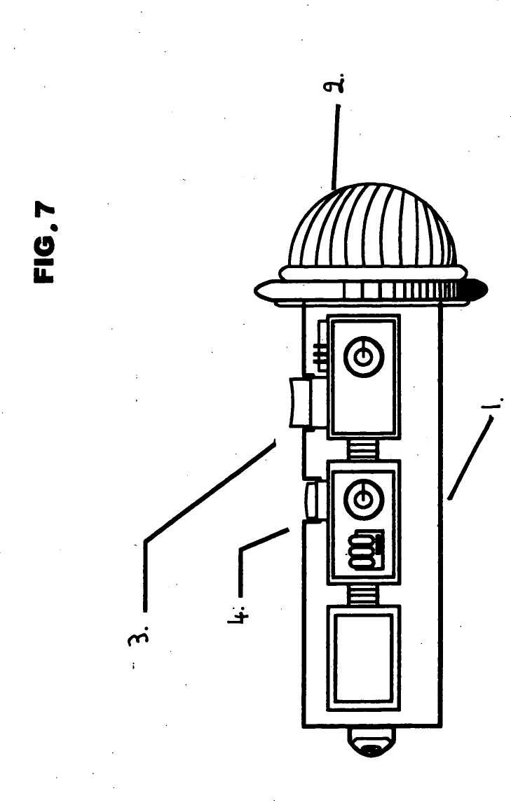

Drawing FIG. 7 is a side cut away view of the two activation means.

### NUMERALS OF THE EMBODIMENT

1) housing
2) speaker
3) raised activation button
4) recessed activation button
5) strap
6)
7) electric watch
8) compatible receiver
9) power source
10) whistle sound chip
11) transmitter control board
12) connections
13) learn button on receiver
14) sound control board
15A) cylinder sleeve for the top button
15B) cylinder sleeve for bottom button
15C) bottom of cylinder for top button.
15D) bottom of cylinder for bottom button
16) antenna on time transmitter
17) sound contact points
18) learn mode software
19) sound transmitter antenna
20) whistle circuit connection
21) contact points connecting the raised button
22) contact points connecting the recessed button
23) resistance spring below raised button
24) spring on recessed button

### DETAILED DESCRIPTION OF THE DRAWINGS

This invention concerns one or more portable remote devices used at a sports event by one of more officials who are involved with the game, who control and interpret the rules. The actual remote control device is carried in the hand or worn from a strap, with the ability on activation to sound a whistle, at that activation location, or just transmit in code to other compatible related equipment, to either emit the sound of a whistle, with or without controlling on or off the field compatible timepieces, or the option to start or stop game related time pieces, that are on or off the field, with no whistle sound being heard.

Referring to FIG. 1. clearly shows all of the components that are incorporated on the outside of the cylindrical housing (1) such as the two activation buttons (3) and (4) that are required to activate the integral mechanism, which fits into the palm of either hand or can be carried from a strap (5) or worn around the neck, while at the other end of the housing (1) is the speaker (2) to emit the whistle sound.

Referring to FIG. 2. a wrist stop watch (7) is used for the purpose of illustrating a crucial component allowing this and other time pieces or whistle sound related equipment to become compatible and work within a group. The learn button (13) is shown on the game time piece, with the face of the watch in place.

This wristwatch can also be in the form of a large game clock visible for all to see that can be stopped or started, with no whistle sound being heard, or with a whistle sound accompanied with the clock being altered.

Referring to FIG. 3. this clearly shows the working components of this remote device, with the speaker (2) at one end, with the carrying strap (5) at the other end. The power source (9) is connected (12) to all aspects of the internal electronic components. The sound control board (14) that assists the whistle sound to be emitted at activation from the speaker (2) carries the whistle chip (10) with the antenna (19) to transmit the coded signal to other compatible whistle related equipment on or off the field. This is activated when the top button (3) which is slightly raised, for ease of identification, on the housing (1) is pressed downward and encounters resistance, allowing the safety phase feature to come into effect, so that only the connection for the whistle with sound and transmission, is heard and transmitted, from the sound control board (14) so that no inadvertent coded signal should be forwarded to any other on or off the field game timepieces, by completing the circuit to transmit a coded signal to related timepieces. In the case of some sports requiring a whistle sound to be emitted when another remote is activated, the electronics (12) can be included in other remote devices, allowing a whistle sound to be emitted from all remotes involved with that game.

This same top button (3) when pushed beyond this safety phase, allows the circuit from the sound control board (14) to the transmitter control board (11) to be completed, then via the antenna, on the time transmitter (16) the transmission of a coded signal to compatible receivers to start or stop a game time piece on or off the field is sent.

The slightly recessed lower button (4) is located just below the housing (1) surface so that it should not be mistaken for the top button (3). When this lower button (4) is activated, resistance is encountered, allowing initially only the circuit to transmit a coded signal to on or off the field related game time pieces, with no whistle sound option, to be sent the coded signal. The same transmitter control board (11) that the top button (3) utilizes is brought into the loop, to perform the function of alerting all related time equipment to stop or start.

This recessed activation button (4) performs another very important function in this whole setup. This activation button (4) has to overcome resistance that has been incorporated as the safety feature before going into the learn mode sequence. Then on being held down for 3 seconds, engages the learn mode software (18) in the transmitter control board (11) that assists in lining up the required compatible, on or off the field components with the compatible receiver, to accept the coded signal, while the learn mode software button in those components that are going to establish compatibility are simultaneously being held down for 3 seconds, whereby whistle and time related equipment can be engaged to perform their task on or off the field, becoming a secure compatible group. The components do not, all have to be matched up at the same time, as they can be set up individually.

Referring to FIG. 4. the face of the stop watch (7) on the field of play has been removed so that the internal related components are visible. The same internal electronics can be found, in on the field small or large off the field watch related equipment, that can accept the coded signal to perform the task of starting or stopping, for others to see the game time. This game related time pieces might also be equipped with the components that allows them to sound a whistle at their location or locations.

The main official, before the start of the game, as a matter of routine has all of the watches on or off the field set to the same allowed playing time, for that game. Then to make all of the equipment that is going to be used compatible, this lower activation button (4) is pushed downwards through the safety phase and held down for 3 seconds on the remote device housing (1) causing activating of the learn mode software (18), in the housing (1), while that person or others at the same time are pushing the learn mode button (13) on any other remote, time piece or whistle related equipment for 3 seconds to allow the receiver (8) in that piece of equipment, with that software to accept the coded signal, to establish compatibility, thereby being able to work within that group so they accept the coded signal. This method is applied, should only one other piece of equipment be required to be made compatible, during or at another location.

Referring to FIG. 5. shows the activation button (3) slightly raised on the housing (1) for ease of identification, with the spring (23) attached underneath. When this activation button (3) is pushed downward, the resistance feature is encountered that has been incorporated by a spring (23), causing the sound contact points (17) to be engaged first, inside the cylindrical sleeve (15A), thereby allowing the whistle sound circuit connection (20) to be completed to the sound control board (14) allowing the whistle sound to be heard at activation location, while sending a coded signal to whistle related equipment on or off the field, whereby a whistle sound is emitted from the various compatible whistle sound equipment.

When the resistance phase of the spring (23) is overcome by pushing the activation button (3) more firmly downward in the cylindrical sleeve (15A), thereby closing the contact points (21) connecting the raised button (3) to the transmitter control board (11) whereby the circuit is now completed and a coded signal is transmitted to watch compatible related equipment on or off the field, to start or stop a time piece, whereby the whistle sound has been emitted fractionally earlier, yet having nothing what so ever, to do with the actual mechanism for controlling any game time piece.

The cylindrical sleeve (15A) is open at the top to accommodate the top activation button (3) allowing it to move inside the sleeve, with the bottom seal (15C) which is required to close that end protruding into the housing (1) making it waterproof.

Referring to FIG. 6. shows the bottom activation button (4) slightly recessed in the cylindrical sleeve (15B), so that it should not be confused with the whistle/time activation button (3) on the housing (1). The top of the cylindrical sleeve (15B) is open, to allow the bottom activation button (4) to move freely downward until resistance is encountered in this sleeve (15B) while also being sealed at the bottom of the cylinder (15D), which protrudes into the housing (1), making the sleeve (15B) waterproof. The spring (24) causes resistance, allowing initially only the connection (22) to be completed, so that a coded signal can be transmitted, to compatible time equipment, with no sound equipment being involved. When the resistance of the safety phase is overcome, by pushing this button (4) more firmly downwards and then being held down in that position for 3 seconds, the means, to synchronize with other related equipment in this group to be become compatible, is achieved.

Referring to FIG. 7. this view shows the location of the activation buttons (3) and (4) more clearly on the housing (1) just below the speaker (2) with each having a very different profile on the housing (1).

Accordingly, the main objective of this invention is a simple means to instantly transmit a coded signal from one or more remote devices, involved with that sport or game, to compatible receivers on or off the field, to initiate a whistle sound at activation location on or off the field, with the option to either start or stop a clock or watch, virtually simultaneously, with or without a whistle sound being heard. This will increase the accuracy of time keeping at sports events, also simplify the officials task of keeping the game time, with the option of having a whistle sound or other time keeping equipment, on or off the field, for players, other officials, participants and spectators, to hear the whistle or see the game time.

The remote device is waterproof. This one or other remote devices or related compatible equipment that are fitted with the electronic means, can be moved to other locations, should even a battery fail, or a component malfunction, a new group can then very simply be configured to work once again as a secure unit, that can even be passed from one official to another very easily, while also allowing fields to be next to each other with no interference. These and other features of the invention will become more apparent upon review of the various adaptations and associated drawings that are appended hereto. It is from these materials as a whole that the scope of protection sought by the inventor may be gleamed.

What I claim as my invention is:

1) One or more remote control devices that are used at a sports event, by an official or officials, at that game, that control whistle or game time pieces, that are on or off the field comprising.
A) A cylindrical housing that can be carried in the palm of either hand or worn from a strap.
B) All of the components for activation are located in or on the housing.

2) Each remote control device of claim (1) has two very distinctive, different means for activation, so that no confusion occurs by one being activated inadvertently.
A) The top activation member is slightly raised on the housing.
B) The bottom activation member is slightly recessed on the housing.

3) The device of claim (2) has a safety feature incorporated within each activation means.
A) The reason being that each activation member can perform two very different objectives.

4) The top activation member of claim (2) on initially being pushed downwards will encounter slight resistance.
A) Allowing only the whistle sound circuit to be completed and heard at activation location.
B) This will also cause a coded signal at the same moment to be sent to all compatible whistle equipment that are on or off the field to sound a whistle.
C) Pushing more firmly downwards overcomes the resistance of the safety feature.
D) Thereby closing the circuit allowing the transmission of a coded signal to be transmitted, to start or stop all watch related equipment, on or off the field that is involved with that specific game.
E) The sound of a whistle heard earlier, has nothing what so ever to do with any game time piece being started or stopped.

5) The lower activation member of claim (2) on initially being pushed downwards will encounter slight resistance.
A) Allowing only the transmission of a coded signal to be transmitted, to start or stop all compatible watch related equipment, on or of the field involved with that specific game.
B) No whistle sound components are involved with this activation means.
C) Pushing more firmly downwards overcomes the resistance of the safety feature.
D) Thereby engaging the learn mode sequence for the electronics and software to be become operation.
E) This activation member while in this learn mode, has to be held down for 3 seconds, in conjunction with all the other related equipment, whose activation member also has to be held down simultaneously, for a period of 3 seconds.
F) Thereby causing all of the related equipment to become compatible in a secure group.
G) This allows many fields to be next to each other, replace a component, or be taken to another venue and setup to once again work in a secure group.
